(19) United States
(12) Patent Application Publication
(10) Pub. No.: US 2019/0243014 A1
(43) Pub. Date: Aug. 8, 2019

(54) SEISMIC CABLE DEPLOYMENT SYSTEM

(71) Applicant: SHELL OIL COMPANY, HOUSTON, TX (US)

(72) Inventors: Grant Slack IRWIN, Austin, TX (US); Steven James MAAS, Pflugerville, TX (US)

(21) Appl. No.: 16/312,144

(22) PCT Filed: Nov. 29, 2016
(86) PCT No.: PCT/US2016/063992

§ 371 Date: Dec. 20, 2018

Related U.S. Application Data
(60) Provisional application No. 62/353,681, filed on Jun. 23, 2016.

(51) Int. Cl. G01V 1/16; B65H 49/34; B65H 51/10; B65H 59/22

(52) U.S. Cl. CPC G01V 1/168; B65H 59/22; B65H 51/105; B65H 49/34

(57) ABSTRACT

A seismic cable deployment system is equipped with a cable puller comprising a windlass. A seismic cable follows a cable path extending from a storage unit to the cable puller, where the cable path extends in a circumferential direction deflected around a cylindrical drum surface and confined between the cylindrical drum surface and a drum-side surface of a tension belt which is pressed against the cylindrical drum surface by two pulley rollers being disposed on either side of the cylindrical drum surface. A belt tensioner is configured to impart elastic tension to the tension belt and a motor is configured to impart rotational motion to the cylindrical drum surface and translational motion to the tension belt.

### FIELD OF THE INVENTION

The present invention relates to a seismic cable deployment system. The seismic cable deployment system may be positioned on a mobile unit, such as on a cargo deck of a truck, and/or otherwise be comprised in a mobile unit for deploying a seismic cable.

### BACKGROUND OF THE INVENTION

Seismic acquisition of subsurface earth structures can be useful for a variety of activities involving the subsurface, including for instance exploration of oil and gas, and monitoring geological formations and/or reservoirs during production of oil and gas and/or during injection of fluids into such formations and/or reservoirs. Seismic sensors may be positioned in a spread about a surface location for sensing properties of the subsurface structures. Such seismic sensors may be housed in sensor stations that may be distributed on a seismic cable.

For land-seismic, sensor stations may each comprise a housing supported on a spike, which may be driven into the ground in order to hold the sensor stations in place and in good vibration contact with the ground. An example of such a sensor station on an optical seismic cable is described in US pre-grant publication No. US 2015/0043310. Seismic cables with seismic sensor stations may also be deployed off-shore, whereby the seismic cable is deployed on the bottom of the sea.

Such seismic cables with sensor stations thereon may be transported to a given location in some kind of storage unit, such as a bin or a reel. A cable puller is typically employed to advance the cable from the storage unit and to distribute the cable in the seismic field at the location. US pre-grant publication No. 2015/0041580 describes a mobile unit carrying a reel on which the seismic cable is disposed, an accumulator guide sheave, and a tensioner configured to pull the cable from the reel. The tensioner includes of a top plate, tension guides and tension rollers sandwiched between the tension plate and the tension guides. The tension guides each rotationally support one of the tension rollers. The tension rollers have guide channels thereon for guiding sensor stations as they pass there between. A passageway is defined partly between the tension rollers for guiding the cable and the bodies of the sensor stations there through, and partly between the tension guides for guiding spikes extending from the bodies of the sensor stations. The tension guides each have curved surfaces defining a portion of the passageway there between for passing the spikes of the sensor stations there through.

### SUMMARY OF THE INVENTION

In accordance with a first aspect of the present invention, there is provided a seismic cable deployment system comprising:
a storage unit;
a cable puller;
a length of seismic cable;
   wherein the cable puller comprises:
a windlass comprising a cylindrical drum surface extending circumferentially around a central axis and rotatable about said central axis;
first and second pulley rollers, each comprising a cylindrical roller surface extending circumferentially around a roller axis and rotatable around said roller axis, whereby each roller axis is configured parallel to the central axis and whereby a roller plane is defined that extends parallel to the central axis and tangentially contacts both the cylindrical roller surfaces of the first and second pulley rollers there where a tangential direction of rotation of the cylindrical roller surface of the first pulley roller is aligned with the tangential direction of rotation of the cylindrical roller surface of the second pulley roller;
a tension belt comprising a drum-side surface and a roller-side surface which faces away from the drum-side surface, said tension belt extending at least between the first and second pulley rollers whereby contacting the first and second pulley rollers with the roller contact surface, and being deflected from the roller plane by the cylindrical drum surface, whereby the drum-side surface faces towards the cylindrical drum surface and whereby the roller-side surface faces towards the first and second pulley rollers;
a belt tensioner configured to impart elastic tension to the tension belt;
a motor configured to impart rotational motion to the cylindrical drum surface about the central axis and translational motion to the tension belt;
   wherein the seismic cable follows a cable path extending from the storage unit to the cable puller where the cable path extends in a circumferential direction deflected around the cylindrical drum surface and confined between the cylindrical drum surface and the drum-side surface of the tension belt.

### BRIEF DESCRIPTION OF THE DRAWING

The invention will be further illustrated hereinafter by way of example only, and with reference to the non-limiting drawing. The drawing consists of the following figures:

FIG. 1 shows a schematic side view of a mobile unit carrying a seismic cable deployment system;

FIG. 2 shows a schematic perspective view of the seismic cable deployment system from FIG. 1;

FIG. 3 shows a first schematic perspective view on the cable puller of the seismic cable deployment system;

FIG. 4 shows the geometry of pulley rollers around a cylindrical drum surface; and

FIG. 5 shows a second schematic perspective view on the cable puller of the seismic cable deployment system from a different vantage point than in FIG. 3.

These figures are schematic and not to scale. Identical reference numbers used in different figures refer to similar components. Certain construction frame parts that obscure the view have been left out for reasons of transparency.

### DETAILED DESCRIPTION OF THE INVENTION

The person skilled in the art will readily understand that, while the invention is illustrated making reference to one or more a specific combinations of features and measures, many of those features and measures are functionally independent from other features and measures such that they can be equally or similarly applied independently in other embodiments or combinations.

The presently proposed seismic cable deployment system uses a cable puller based on a windlass. The seismic cable follows a cable path extending from a storage unit to the cable puller, where the cable path extends in a circumferential direction deflected around a cylindrical drum surface and confined between the cylindrical drum surface and a drum-side surface of a tension belt which is pressed against the cylindrical drum surface by two pulley rollers being disposed on either side of the cylindrical drum surface. A belt tensioner is configured to impart elastic tension to the tension belt and a motor is configured to impart rotational motion to the cylindrical drum surface and translational motion to the tension belt.

One function of the belt tensioner is to allow the right amount of slack in the tension belt when an object such as a seismic sensor is dragged between the tension belt and the cylindrical drum surface, while at the same time keeping the tension belt under some tension to ensure the seismic cable is coupled to the motion of the cylindrical drum surface. Once the object has passed through the confinement between the tension belt and the cylindrical drum surface, the slack is undone while still keeping the tension belt under tension. The tension in the tension belt may thus stay within a certain pre-determined range, regardless of which portion of the seismic cable is caught between the tension belt and the cylindrical drum surface.

The proposed cable puller is much more robust against failure and snags due to misaligned sensor stations than the tensioner described in US pre-grant publication No. 2015/0041580. The range of the tensioner can be selected as large as needed to allow the sensor stations to pass in any orientation they may have compared to the cylindrical drum surface, even with their spikes pointing radially outwardly from the cylindrical drum surface.

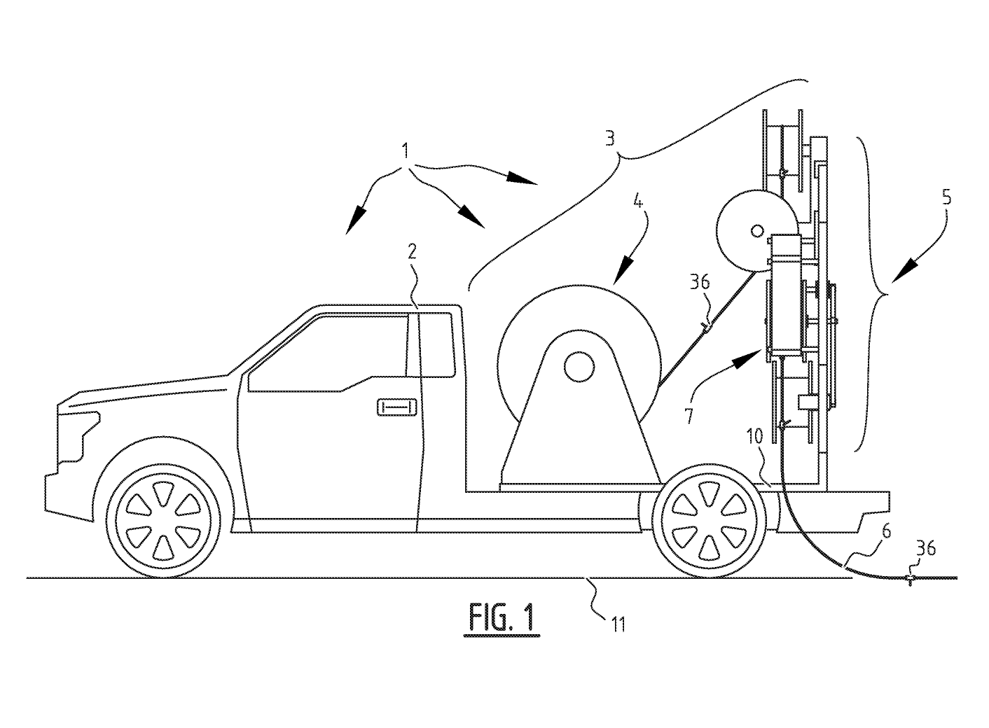

FIG. 1 shows a mobile seismic cable deployment unit 1 comprising a mobile unit, here schematically shown in the form of a truck 2, and a seismic cable deployment system 3. The truck 2 is supported on the ground 11, on which it can move. The seismic cable deployment system 3 comprises a storage unit 4 and a cable puller 5. The mobile seismic cable deployment unit 1 is adapted to deploy a length of seismic cable 6 on a surface land in a seismic survey area. The seismic cable 6 may be of any construction that is suitable for it purpose. The seismic cable 6 may for instance be a smooth cable having discrete sensors and/or distributed sensors integrated into the cable. Other types of seismic cable 6 may comprise external sensor stations 36 that are interlinked with each other on the seismic cable 6. Such external sensor stations 36 may be provided with a spike that can be inserted into the ground. An example of such external sensor stations 36 provided with spikes seismic cable is shown in US pre-grant publication No. US 2015/0043310.

Between the cable puller 5 and the ground 11 there is a fairlead mounted on the construction frame 10, to guide the seismic cable 6. Between the cable puller 5 and the fairlead there is a wind protection shute, though which the seismic cable 6 goes.

The cable puller 5 puts the seismic cable 6 under a tension between the storage unit 4 and the cable puller 5. The tension in the seismic cable 6 between the storage unit 4 and the cable puller 5 helps to avoid tangling of the seismic cable 4 during deployment operations. Under this tension, the seismic cable 6 can be dispatched from the storage unit 4, whereby the amount of tension on the cable 6 is decoupled from any tension that may exist in the seismic cable 6 between the cable puller 5 and the ground 11 on which the seismic cable 6 is deployed.

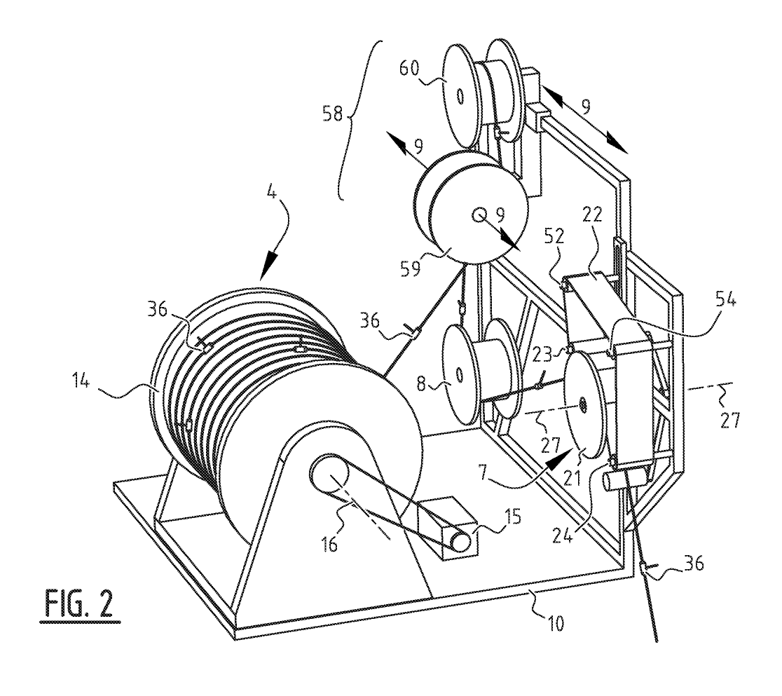

The seismic cable puller 5 is based on a windlass 7. The storage unit 4 and cable puller 5, which may be mounted on a construction frame 10, are shown in more detail in FIG. 2. As illustrated in FIG. 2, the storage unit 4 suitably comprises a storage reel 14, whereby at least a part of the length of the seismic cable 6 is disposed on the storage reel 14. However, other storage means may be employed instead, such as for example a bin or a crate or a cargo space in which the at least part of the length of the seismic cable 6 can be deposed. When a storage reel 14 is employed, the storage reel 14 may advantageously be driven by a storage reel drive motor 15, in order to lower the tension in the seismic cable 6 while it is being dispatched from the storage reel 14.

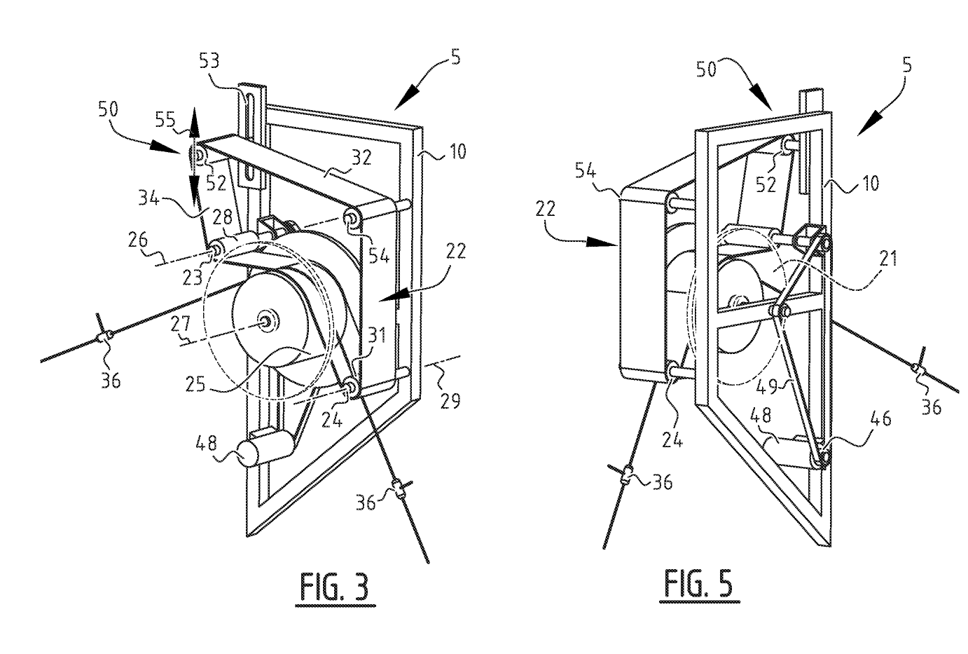

The windlass 7 comprises a windlass reel 21 and a tension belt 22 that cooperates with the windlass reel 21. Tension belt 22 is guided by a number of pulley rollers (23,24,54). Specifically, the tension belt 22 is brought into contact with the windlass reel 21 by first pulley roller 23 and second pulley roller 24. Referring to FIG. 3, it is illustrated that the a windlass reel 21 comprises a drum having a cylindrical drum surface 25 extending circumferentially around the central axis 27. The windlass reel 21, with the cylindrical drum surface 25, is rotatable about the central axis 27.

An entry guide 8 (which can be a reel, may also be referred to as “a dancer”) is suitably configured between the storage unit 4 and the cylindrical drum surface 25. The entry guide 8 serves to regulate the tension in the seismic cable 6. The tension in seismic cable forces the entry guide 8 in upward direction, and it is pushed back with a counter force. If the seismic cable 6 pulls too hard, the entry guide 8 will move up. The displacement of the entry guide 8 will be measured and cause a feed-back signal to motor 15 to speed up. Conversely, if motor 15 is too fast, the tension in the seismic cable will not pull hard enough so the entry guide 8 will slide down. This displacement causes a feed-back signal to motor 15 to slow down.

Thus the entry guide 8 may be a stationary guide such as a guide ring or the like, or it may, as illustrated in FIG. 2, be a drum that is rotatable about a stationary axis.

In FIG. 2, it is shown that the seismic cable 6 is dispatched from the storage reel 14 from the bottom. However, the person skilled in the art would appreciate that, in practice it can also be arranged differently, e.g. from the top, meaning that whether the seismic cable 6 is dispatched from the bottom or the top is not so important.

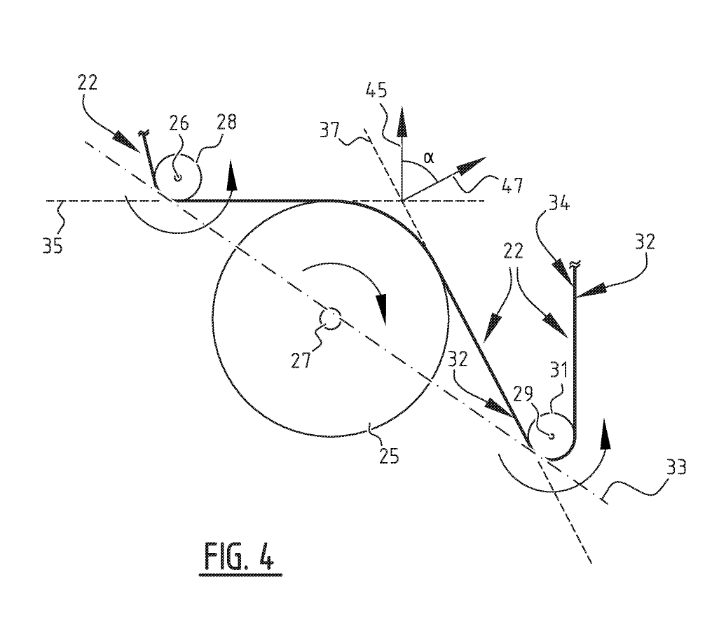

The first and second pulley rollers (23,24) each comprise a cylindrical roller surface (28,31) extending circumferentially around a roller axis (26,29). The geometry of the first and second pulley rollers relative to the cylindrical drum surface 25 of the windlass reel 14 is shown in FIG. 4. The respective cylindrical roller surface (28,31) is rotatable around its roller axis (26,29). Each roller axis (26,29) is configured parallel to the central axis 27. A roller plane 33 is defined, which extends parallel to the central axis 27 and tangentially contacts both the cylindrical roller surfaces of the first (23) and second (24) pulley rollers there where a tangential direction of rotation of the cylindrical roller surface 28 of the first pulley roller is aligned with the tangential direction of rotation of the cylindrical roller surface 31 of the second pulley roller.

Referring, again, to FIG. 3, the tension belt 22 has a drum-side surface 32 and a roller-side surface 34. The roller-side surface 34 faces away from the drum-side surface 32. The tension belt 22 extends at least between the first and second pulley rollers (23,24). The cylindrical roller surfaces (28,31) of each of the first and second pulley rollers (23,24) are each in contact with the roller-side surface 34 of the tension belt 22. As can be best seen in FIG. 4, the tension belt 22 is deflected from the roller plane 33 by the cylindrical drum surface 25, whereby the drum-side surface 32 of the tension belt 22 faces towards the cylindrical drum surface 25 and whereby the roller-side surface 34 of the tension belt 22 is in contact with the first and second pulley rollers (23,24). The seismic cable 6 follows a cable path that extends from the storage unit 4 to the cable puller 5, whereby the cable path extends in a circumferential direction deflected around the cylindrical drum surface 25 and is confined between the cylindrical drum surface 25 and the drum-side surface 32 of the tension belt 22.

As can be seen in FIG. 4 in more detail, a first part of the tension belt 22 extends in a first belt plane 35 between the cylindrical roller surface 28 of the first pulley roller 23 and the cylindrical drum surface 25. A second part of the tension belt 22 extends in a second belt plane 37 between the cylindrical roller surface 31 of the second pulley roller 24 and the cylindrical drum surface 25. The first belt plane 35 has a first normal direction, indicated by arrow 45 directed away from the cylindrical roller surface 25. Likewise, the second belt plane 37 has a second normal direction, indicated by arrow 47 that is also directed away from the cylindrical roller surface 25. The first pulley roller 23 and the cylindrical drum surface 25 are on opposite sides of the first belt plane 35. Likewise, the second pulley roller 24 and the cylindrical drum surface 25 are on opposite sides of the second belt plane 37.

The first and second belt planes (35,37) deviate from the roller plane 33. As can be seen, a non-zero belt contact angle α, defined as an angle between the first normal direction 45 of the first belt plane 35 and the second normal direction 47 of the second belt plane 37 exists. Preferably, the belt contact angle α is in a range of between 45° and 135°, preferably in a range of between 45° and 90°. Herewith it is achieved that the tension belt 22 substantially follows the cylindrical drum surface 25 over a sufficiently large segment of the arc defined by the cylindrical drum surface 25, while at the same time allowing accessibility of the space between the tension belt 22 and the cylindrical drum surface 25 on both sides for the seismic cable 6.

Suitably, a belt tensioner 50 is configured to impart elastic tension to the tension belt 22. The belt tensioner 50 may be configured to keep the tension in the tension belt 22 within a pre-determined range. The tension in the tension belt 22 should be sufficiently high to engage the seismic cable 6 with sufficient pressure between the tension belt 22 and the cylindrical drum surface 25 to advance the seismic cable 6 along, preferably at the same velocity as the cylindrical drum surface 25 without slipping. Suitably, there is friction between the cylindrical drum surface 25 and the drum-side surface 35 of the tension belt 22, such that the cylindrical drum surface 25 and the drum-side surface 35 of the tension belt 22 move at the same angular velocity when the cylindrical drum surface 25 is in rotational motion. The cylindrical drum surface 25 may drive the tension belt 22, or vice versa.

The belt tensioner 50 can be embodied in various ways. Suitably, the belt tensioner 50 has a tension roller 52 in contact with the tension belt 22. The tension roller 52 is transversely movable relative to the drum-side and roller-side surfaces (32,34) of the tension belt 22, to deflect the tension belt 22 to a variable degree. As shown in FIG. 3 a guide rail 53 may be provided, in which the tension roller 52 can move as described. The transverse movability is schematically indicated by arrows 55. The tension may be imparted on the tension belt 22 in various ways. Examples include pulling the tension roller 52 by means of a mechanical spring, or by a hydraulic or pneumatic system.

The purpose of the belt tensioner 50 is to maintain pressure from the tension belt 22 on the cylindrical drum surface 25. If the seismic sensor stations 36 are sized relatively large compared to the cable diameter, the belt tensioner 50 may move inward to provide the slack necessary for tension belt 22 to provide the space needed to capture the sensor station between the tension belt 22 and the cylindrical drum surface 25 without crushing or otherwise damaging the sensor station 36 and without stalling the movement of the seismic cable 6 though the cable puller 5. When the sensor stations 36 are provided with a spike, and wherein the tension roller 52 is preferably movable within a range that is sufficient to allow the sensor stations 36 to pass between the cylindrical drum surface 25 and the drum-side surface 32 of the tension belt 22 in an orientation whereby the spike protrudes radially outward away from the cylindrical drum surface 25.

It is understood that the material of which the tension belt 22 is made is capable of resisting being punctured by the spikes. This also sets a desired upper limit to the tension that is imparted on the tension belt 22 by the belt tensioner 50. This should be worked out on a case-by-case basis taking into account the specific requirements of each deployment.

A motor 48 is suitably configured to impart rotational motion to the cylindrical drum surface 25 about the central axis 27, and translational motion to the tension belt 22. The motor 48 may be operationally coupled to the cylindrical drum surface 25. As shown in FIG. 5, this may be accomplished by a motor drive belt 49 that engages to the motor output shaft 46 and the windlass reel 21. The motor drive belt 49 may be distinct from the tension belt 22. Optionally there is a gear box configured to reduce the number of revolutions of the cylindrical drum surface per unit of time (the angular velocity).

The tension belt 22 may be driven by the motor 48 via the windlass reel 21, by making use of friction between the drum-side surface 32 of the tension belt 22 and the cylindrical drum surface 25. However, the motor drive belt 49 may in addition to engaging with the windlass reel 21, or instead thereof, engage with a drive pulley roller. As shown in the present figures, the drive pulley roller coincides with the first pulley roller 23. Alternatively, the drive pulley roller may coincide with the second pulley roller 24, or with a third pulley roller 54 that is distinct from the first and second pulley rollers (23,24). The drive pulley roller may instead thereof coincide with the tension roller 52, but this appears to be unnecessarily complicated as the tension roller 52 is arranged to move transversely to its axis of rotation.

The rotational axis of the third pulley roller 54 is auto-aligning by means of a spherical ball bearing with a roller bearing of the third pulley roler 54.

It is optional to drive the cable puller 5 by motor 48 engaging with the drive pulley roller and then set the windlass reel 21 in motion via the tension belt 22 by making use of friction between the drum-side surface 32 of the tension belt 22 and the cylindrical drum surface 25. In the example shown in FIG. 5, the motor drive belt 49 extends to the drive pulley roller to drive the tension belt 22 as well as the windlass reel 21. In such embodiments wherein the motor drive belt 49 engages with both the windlass reel 21 and one or more of the pulley rollers, the rotational tangential surface velocities of the drive pulley roller and the cylindrical drum surface 25 can be equalized using at least one gearing mechanism, preferably the gear box that may be configured on the windlass reel 21.

The storage reel 14 is suitably rotatable about a storage reel axis 16 that is aligned perpendicular to the central axis 27 of the windlass 7. This allows the use of an optional level wind 58 configured to move back and forth (as indicated by arrows 9) parallel to the storage reel axis 16 and a plane that is perpendicular to the central axis 27 of the windlass 7, to suitably align the cable with a selectable section of the storage reel 14. The optional level wind 58 suitably has two cable guide drums: a first cable guide drum 59 disposed between the storage reel 14 and a second cable guide drum 60. The second cable guide drum 60 is disposed between the first cable guide drum 59 and the entry guide 8. Suitably, the first cable guide drum 59 the second cable guide drum 60 are linearly translatable in unison in a direction parallel to the storage reel axis 16, as schematically indicated in FIG. 2 by arrows 9.

Suitably, the first cable guide drum 59 rotates about a first cable guide drum axis that is parallel to the storage reel axis 16, while the second cable guide drum 60 rotates about a second cable guide drum axis that is perpendicular to the first cable guide drum axis. The second cable guide drum axis may be parallel to the stationary axis of the entry guide 8 in the event the entry guide 8 is an entry guide drum. In the latter case, the stationary axis of the entry guide 8 is suitably parallel to the central axis 27 of the windlass reel 21.

The seismic cable deployment system may further comprise a radio frequency identification unit (RFID unit) capable of reading RFID tags that may be provided on the sensor stations 36. At the same time, a position is determined and recorded using a global positioning system (GPS) and/or a real time kinematic (RTK) unit for an even higher accuracy. This way, the exact position of each deployed sensor station 36 in the cable is accurately known and recorded.

Ideally, the seismic cable deployment system as described herein is employed to deploy the seismic cable 6 free from tension or substantially free from tension as it is laid out on the ground. The seismic cable deployment system may further comprise a tension sensor to gauge the tension in part of the seismic cable 6 that has been dispatched from the cable puller 5, e.g. the part of the seismic cable 6 that is located between the cable puller 6 and the ground. The tension sensor may provide feedback to intervene with the seismic cable deployment operation. Intervention may involve one or more of a number of intervening actions, including for instance slowing down the cable deployment rate, increasing the cable deployment rate, adjusting of the tension on the tension belt 22 to regulate the amount of “freewheeling” allowed on the windlass reel 21, interrupting the deployment operation, etc.

It is anticipated that the seismic cable deployment system described herein is capable of rapid deployment of the seismic cable 6, at a deployment rate of possibly up to 10 km of seismic cable per hour. The description as provided above has been made using a land-deployment system as example. However it will be understood that the seismic cable deployment system described herein can also be used for off-shore deployment of seismic cables on an ocean floor. In an off-shore setting, the seismic cable deployment system disclosed herein may for instance be employed to instead of the cable pulling deployment system that is described in U.S. Pat. No. 5,624,207. In such deployments, the mobile unit would not be a truck but for instance a barge, a ship, or anything else that can provide a floating platform.

The person skilled in the art will understand that the present invention can be carried out in many various ways without departing from the scope of the appended claims.

1. A seismic cable deployment system comprising:
a storage unit;
a cable puller;
a length of seismic cable;
wherein the cable puller comprises:
a windlass comprising a cylindrical drum surface extending circumferentially around a central axis and rotatable about said central axis;
first and second pulley rollers, each comprising a cylindrical roller surface extending circumferentially around a roller axis and rotatable around said roller axis, whereby each roller axis is configured parallel to the central axis and whereby a roller plane is defined that extends parallel to the central axis and tangentially contacts both the cylindrical roller surfaces of the first and second pulley rollers there where a tangential direction of rotation of the cylindrical roller surface of the first pulley roller is aligned with the tangential direction of rotation of the cylindrical roller surface of the second pulley roller;
a tension belt comprising a drum-side surface and a roller-side surface which faces away from the drum-side surface, said tension belt extending at least between the first and second pulley rollers whereby contacting the first and second pulley rollers with the roller contact surface, and being deflected from the roller plane by the cylindrical drum surface, whereby the drum-side surface faces towards the cylindrical drum surface and whereby the roller-side surface faces towards the first and second pulley rollers;
a belt tensioner configured to impart elastic tension to the tension belt;
a motor configured to impart rotational motion to the cylindrical drum surface about the central axis and translational motion to the tension belt;
wherein the seismic cable follows a cable path extending from the storage unit to the cable puller where the cable path extends in a circumferential direction deflected around the cylindrical drum surface and confined between the cylindrical drum surface and the drum-side surface of the tension belt.

2. The seismic cable deployment system of claim 1, wherein a first part of the tension belt extends in a first belt plane between the cylindrical roller surface of the first pulley roller and the cylindrical drum surface, and a second part of the tension belt extends in a second belt plane between the cylindrical roller surface of the second pulley roller the cylindrical drum surface.

3. The seismic cable deployment system of claim 2, wherein a belt contact angle, defined as an angle between a first normal direction of the first belt plane and the a second normal direct of the second belt plane, is in a range of between 45° and 135°, whereby the first and second normal directions are directed away from the cylindrical roller surface.

4. The seismic cable deployment system of claim 2, wherein the first pulley roller and the cylindrical drum surface are on opposite sides of the first belt plane, and wherein the second pulley roller and the cylindrical drum surface are on opposite sides of the second belt plane.

5. The seismic cable deployment system of claim 1, wherein there is friction between the cylindrical drum surface and the drum-side surface of the tension belt such that the cylindrical drum surface and the drum-side surface move at the same angular velocity as the cylindrical drum surface is in rotational motion.

6. The seismic cable deployment system of claim 1, wherein the motor is operationally coupled to the cylindrical drum surface.

7. The seismic cable deployment system of claim 6, wherein the motor is operationally coupled to the cylindrical drum surface via a motor drive belt that is not the tension belt.

8. The seismic cable deployment system of claim 7, further comprising a drive pulley roller in contact with the tension belt, whereby said motor drive belt extends to the drive pulley roller to drive the tension belt via the drive pulley roller.

9. The seismic cable deployment system of claim 1, wherein the belt tensioner comprises a tension roller in contact with the tension belt and transversely movable relative to the drum-side and roller-side surfaces of the tension belt to deflect the tension belt to a variable degree.

10. The seismic cable deployment system of claim 9, wherein the seismic cable comprises sensor stations provided with a spike, and wherein the tension roller is movable within a range that is sufficient to allow the sensor stations to pass between the cylindrical drum surface and the drum-side surface of the tension belt in an orientation whereby the spike protrudes radially outward away from the cylindrical drum surface.

11. The seismic cable deployment system of claim 1, wherein the belt tensioner is configured to keep the tension in the tension belt within a pre-determined range.

12. The seismic cable deployment system of claim 1, wherein the storage unit comprises a storage reel whereby at least a part of the length of seismic cable is disposed on the storage reel.

13. The seismic cable deployment system of claim 13, wherein the storage reel is rotatably driven by a storage reel drive motor.

14. The seismic cable deployment system of claim 12, wherein the storage reel is rotatable about a storage reel axis that is aligned perpendicular to the central axis of the windlass.

15. The seismic cable deployment system of claim 1, wherein the cable puller puts the seismic cable under a tension between the storage unit and the cable puller.

16. The seismic cable deployment system of claim 2, wherein a belt contact angle, defined as an angle between a first normal direction of the first belt plane and the a second normal direct of the second belt plane, is in a range of between 45° and 90°, whereby the first and second normal directions are directed away from the cylindrical roller surface.
